(19) United States
(12) Patent Application Publication
(10) Pub. No.: US 2025/0323819 A1
(43) Pub. Date: Oct. 16, 2025

(54) SYSTEMS, METHODS, AND MEDIA FOR MANAGING AND TRANSFORMING ALERTS GENERATED FOR CLOUD COMPUTING ENVIRONMENTS

(71) Applicant: FMR LLC, Boston, MA (US)

(72) Inventor: Ashutosh Agnihotri, Irving, TX (US)

(21) Appl. No.: 18/633,243

(22) Filed: Apr. 11, 2024

(51) Int. Cl. H04L 41/0604; H04L 41/0631

(52) U.S. Cl. CPC H04L 41/0627; H04L 41/0631

(57) ABSTRACT

Techniques are provided for managing and transforming alerts generated for cloud computing environments. An alert corresponding to a predefined service name is identified. The alert is transformed with enriched data and into a particular format/syntax such that all generated transformed alerts are consistent in terms of format/syntax. The transformed alert is compared to other existing alerts to determine if the transformed alert is new or repetitive. If the transformed alert is new and does not correspond to a paused event, the transformed alert is published. If the transformed alert is repetitive or corresponds to a paused event, the transformed alert is prevented from being published. The enriched data of the transformed alert can include cloud application specific information and other cloud environment specific information not included in the original alert. The enriched data can be used to more effectively monitor/remediate cloud environment issues.

### BACKGROUND

### Technical Field

The present disclosure relates generally to cloud computing environments, and more specifically to techniques for managing and transforming alerts generated for cloud computing environments.

### Background Information

Cloud computing is a paradigm that delivers computing services, including storage, processing power, and applications, over the internet. Instead of relying on local servers or personal devices (i.e., on-premises devices), users/customers can access and use resources that are hosted on remote servers (e.g., cloud storage) by way of the internet. Cloud computing is often characterized by its on-demand availability, scalability, and pay-as-you-go pricing model. Cloud computing can provide various service models, such as Infrastructure as a Service (IaaS), Platform as a Service (PaaS), and Software as a Service (SaaS), thereby catering to diverse business needs.

Cloud computing alerts play an important role in monitoring, managing, and maintaining the health, performance, and security of cloud computing environments. The alerts can be notifications that are generated when predefined conditions or events occur in relation to the cloud computing environment. There are many different alert generation systems that are designed to monitor, detect, and notify users/administrators about specific events or conditions within the cloud computing environment. The alert generation systems may be provided by the cloud computing environment itself (e.g., cloud computing service provider) or may be independently provided by third parties.

In practice, organizations often use a combination of these different alert generation systems to cover different aspects of cloud monitoring, ranging from infrastructure and application performance to security and compliance. The choice of which alert generation system(s) to use may depend on a variety of factors. Such factors may include, but are not limited to, the specific cloud services used, the complexity of the cloud computing environment, and/or the organization's monitoring and alerting requirements.

Understanding the format and syntax of the cloud alerts is essential for effectively monitoring and responding to alerts in cloud computing environments. However, various cloud alert generation systems typically employ different formats and syntaxes for defining and generating alerts. The lack of consistency, in terms of format and syntax, across alert generation systems means that users need to be familiar with many formats and syntaxes to effectively interpret and respond to the generated alerts. Learning and understanding the variety of different formats and syntaxes is tedious, burdensome, and error-prone for users. For example, because of the lack of consistency across alert generation systems, a user may be more likely to misdiagnose a problem in the cloud computing environment, implement an incorrect remediation action in the cloud computing environment, misunderstand the severity of a problem in the cloud computing environment, etc.

Further, and in many instances, the information in the generated alerts can be hard to understand. For example, the alerts may include insufficient details and may use technical terms and/or acronyms that are not familiar to all users. In addition or alternatively, alerts may include insufficient context as to why the alert was triggered or what actions (e.g., remediation actions) should be taken.

An additional existing problem in cloud computing environments is dealing with a barrage of repetitive cloud alerts. Repetitive cloud alerts may be received for a variety of reasons. Such reasons may include, but are not limited to, overly aggressive alert thresholds, false positives, redundant alerts e.g., multiple alerts for the same issue from the same or different monitoring systems, etc.

Handling repetitive alerts can be overwhelming and challenging for users due to several reasons. For example, repetitive alerts can make it difficult for users to identify and prioritize critical issues over non-critical issues. Further, and over time, users can become desensitized to repetitive alerts, which in turn can result in critical issues being overlooked or not receiving the appropriate attention. These are just two examples of the issues that repetitive alerts can cause.

Accordingly, what is needed is a technique for providing consistency across different alert generation systems and limiting repetitive cloud alerts such that monitoring and responding to cloud alerts can be achieved more effectively and efficiently.

### SUMMARY

Techniques are provided for managing and transforming alerts generated for cloud computing environments. Specifically, and as will be described in further detail below, an alert can be transformed into a consistent format/syntax and with enriched data. The transformed alert can be published if it is determined that the transformed alert is new and does not correspond to a paused event. Advantageously, the enriched data from published transformed alerts can be used to monitor and remediate cloud computing issues more efficiently and effectively when compared to conventional systems and techniques.

In an embodiment, a software module (e.g., an advanced signal processing module) executed by a processor may receive an alert from one of a plurality of different alert generation systems that use different formats, syntaxes, information and/or structures to generate and define their respective alerts. The received alert may be referred to as an original alert. The software module may transform an original alert by enriching the original alert with enriched data. In an embodiment, the enriched data may include cloud application specific information (e.g., cloud application name/identifier) and other cloud environment specific information that is (1) not included in the original alert or (2) not easily identifiable in the original alert. In an embodiment, the software module may utilize information in the original alert to query cloud configuration files, tables, and/or other alert generation systems to identify and obtain the enriched data. The software module may also transform original alerts, from different alert generation systems, into a single consistent format and syntax.

In an embodiment, the software module may determine if a transformed alert includes one or more predefined service names. The predefined service names may correspond to alert generation systems that generate alerts and/or recommendations/insights for cloud computing services that are of interest to a user/administrator.

The software module may determine if the transformed alert, identified as corresponding to the one or more predefined service names, is new or repetitive. In an embodiment, the software module may compare the transformed alert with other existing transformed alerts to determine if the transformed alert is new or repetitive. For example, the software module may determine that the transformed alert is repetitive if the transformed alert matches a previously transformed alert, in cloud storage or cache, which was previously published within a user defined time window. When either the transformed alert is repetitive or the transformed event occurs during user defined alert suspension period, the software module determines that the transformed alert should not be published.

If the transformed alert does not match a previously transformed alert, in cloud storage or cache, that was published within the user defined time window, the software module determines that the transformed alert is new. If the transformed alert is new and does not correspond to a paused event, the software module determines that the transformed alert should be published.

If the transformed alert is determined to be published, the software module may generate a new publish field for the transformed alert and store a value in the publish field indicating that the transformed alert should be published. If the transformed alert is determined to not be published, the software module may generate the new publish field for the transformed alert and the publish field may store a value indicating that the transformed alert should not be published.

At one or more predefined times (e.g., when a transformed alert is inserted in cloud storage), the software module may publish all transformed alerts having a publish field indicating that the alert should be published, while also preventing the transformed alerts having a publish field indicating that the alert should not be published. The enriched data from the published transformed alerts may be utilized by users/administrators to monitor and remediate cloud computing issues in a more efficient and effective manner when compared to conventional systems that (1) may not include enriched data in their respective alerts and (2) use varied formats, syntaxes, etc. for defining and generating alerts. Optionally, the software module may analyze a published transformed alert and automatically implement a remediation action to address the cloud computing issue that corresponds to the published transformed alert.

### BRIEF DESCRIPTION OF THE DRA WINGS

The description below refers to the accompanying drawings, of which:

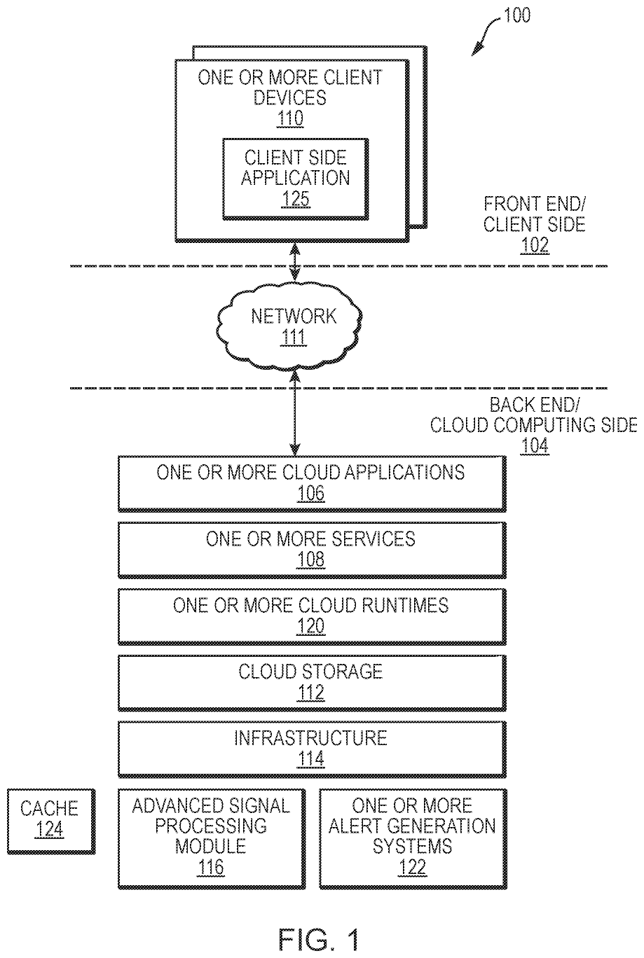

FIG. 1 is a high-level block diagram of an example system architecture for managing and transforming alerts generated for cloud computing environments according to the one or more embodiments as described herein;

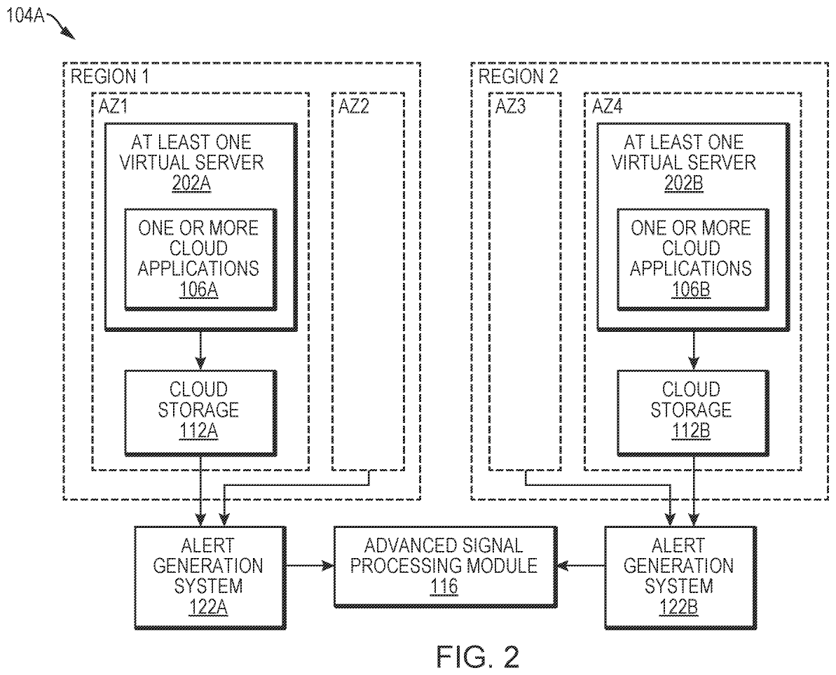

FIG. 2 is a high-level block diagram of an example cloud computing environment, offering Infrastructure as a Service (IaaS), for managing and transforming alerts generated for cloud computing environments according to the one or more embodiments as described herein;

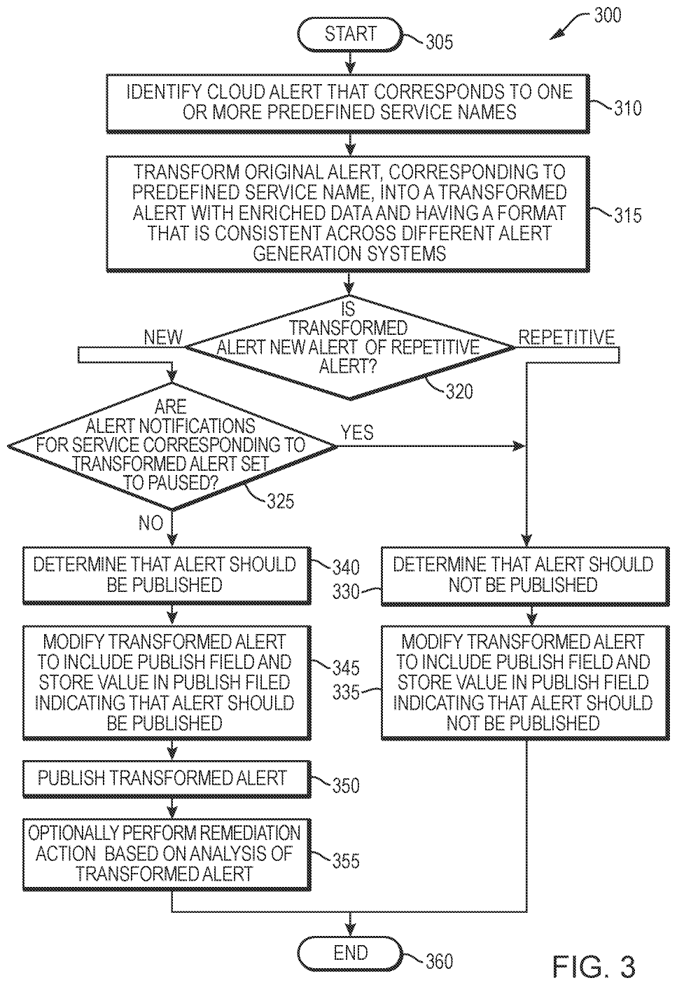

FIG. 3 is a flow diagram of a sequence of steps for managing and transforming alerts generated for cloud computing environments according to the one or more embodiments as described herein; and

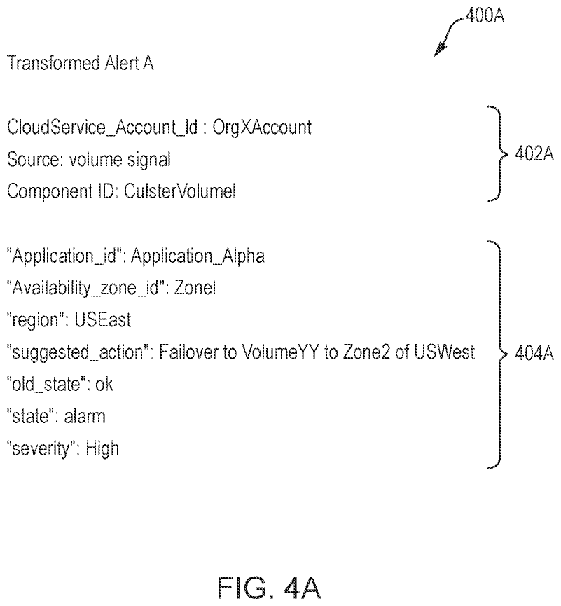

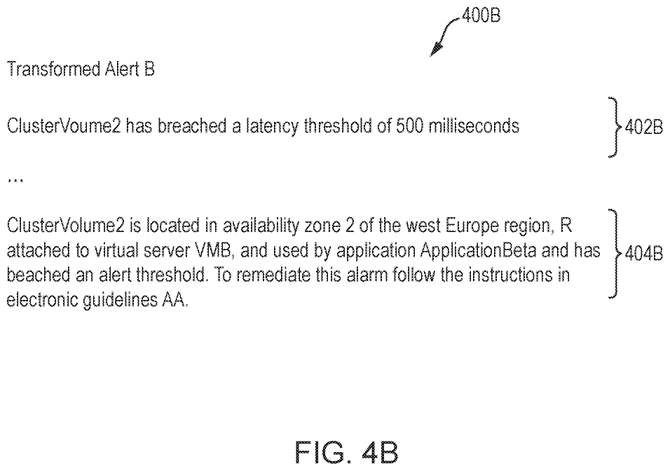

FIGS. 4A and 4B are exemplary transformed alerts according to the one or more embodiments as described herein.

### DETAILED DESCRIPTION OF AN ILLUSTRATIVE EMBODIMENT

FIG. 1 is a high-level block diagram of an example system architecture 100 for managing and transforming alerts generated for cloud computing environments according to the one or more embodiments as described herein. The system architecture 100 may be divided into a front end/client side 102 that includes one or more local client devices 110 that are local to end users, and a back end/cloud computing side 104 that is remote to the end users.

The client side 102 may include one or more local client devices 110. According to the one or more embodiments as described herein, each client device 110 may include processors, memory, a display screen, and/or other hardware (not shown) for executing software, storing data, and/or displaying information. The one or more client devices 110 may provide a variety of user interfaces and non-processing intensive functions.

For example, client device 110 may provide a user interface for receiving user input and displaying output according to the one or more embodiments as described herein. The user interface can be a graphical user interface or a command line interface. In an embodiment, the client device 110 may be a server, a workstation, a platform, a mobile device, a network host, or any other type of computing device.

The client device 110 may be operated by affiliates of an enterprise. In an embodiment, the enterprise is a financial services institution. The affiliates may include employees and/or customers of the enterprise. The client device 110 may communicate with cloud computing side 104 over network 111. For example, and as will be described in further detail below, the client device 110 may access and utilize one or more cloud applications 106 that are hosted, for the enterprise, on cloud computing side 104. In an embodiment, the client device 110 may access the cloud computing side 104 using a web-based dashboard, command-line interface (CLI), an application programming interface (API), etc.

Cloud computing side 104 may be managed by a cloud service provider. As used herein, cloud computing side 104 may be referred to as cloud computing environment 104 and/or cloud-based computing environment 104. Cloud computing environment 104 may include a variety of different components, as depicted in FIG. 1, that are utilized to maintain and operate the cloud computing environment 104. Although FIG. 1 depicts cloud computing environment 104 including particular components, it is expressly contemplated that cloud computing environment 104 may include additional components (not shown) according to the one or more embodiments as described herein.

Cloud computing environment 104 may host any of a variety of different cloud applications 106 for different enterprises, individuals, etc. The cloud applications 106 may be accessed and utilized by client device 110 over network 111. Cloud computing environment 104 may offer one or more services 108. The one or more services 108 may be the functionalities that are used to meet the computing needs of the users and enterprises that access cloud computing environment 104. Such services may be service models that include, but are not limited to, Infrastructure as a Service (IaaS), Platform as a Service (PaaS), and Software as a Service (SaaS).

Cloud computing environment 104 may further include one or more cloud runtimes 120. In an embodiment, the one or more cloud runtimes 120 may be execution environments used for executing/running cloud applications 106. Cloud computing environment 104 may include cloud storage 112 that stores data. Examples of cloud storage 112 may include, but are not limited to, solid-state drives (SSDs), hard disk drives (HDDs), databases, etc. Cloud computing environment 104 may also include infrastructure 114 that is used to support the cloud computing environment 104. Infrastructure 114 may include, but is not limited to, hardware and software components such as processors, servers, network devices, virtualization software, etc. Cloud computing environment 104 may also include cache 124 that can store frequently used data to improve performance and/or reduce latency when accessing data on cloud computing environment 104.

Cloud computing environment 104 may further include one or more alert generation systems 122. According to the one or more embodiments as described herein, each alert generation system 122 may be referred to as an alert service that is operated by an alert service provider.

Each alert generation system 122 may generate an alert and/or recommendation (i.e., insight), which can act as a notification, when predefined conditions or events occur in relation to the cloud computing environment 104. As used herein, an alert may be used to refer to both an alert notification and a recommendation/insight.

As an example, the one or more alert generation systems 122 may generate an alert when one or more metrics, corresponding to the operational behavior of the cloud computing environment 104, meets or exceeds one or more predefined threshold values. As used herein, the terms alert, cloud alert, signal, and notification may be used interchangeably and may refer to any electronic alert or recommendation (i.e., insight) generated by an alert generation system 122 for cloud computing environment 104. The alerts can be transmitted over network 111 to client device 110 to notify users/administrators about specific events or conditions within the cloud computing environment. Each alert generation system may utilize its own format, syntax, information, and/or structure to define and generate alerts. As such, and in an embodiment, there is a lack of consistency for the alerts generated across different alert generation systems 122.

Cloud computing environment 104 may include advanced signal processing (ASP) module 116 that implements the one or more embodiments as described herein. Specifically, and as will be described in further detail below, the ASP module 116 may transform an original alert, generated by different alert generation systems 122, into a transformed alert that is enriched with enriched data and that has a format/syntax that is consistent for all transformed alerts. The enriched data may include cloud application specific information (e.g., cloud application name/identifier) and other cloud environment specific information that is (1) not included in the original alert or (2) not easily identifiable in the original alert. The enriched data provides more details for monitoring and remediating cloud computing issues.

The ASP module 116 may perform an analysis of a transformed alert in relation to previously transformed alerts, stored in cache 124 or cloud storage 112, to actively suppress or limit repetitive alerts as will be described in further detail below. As a result, repetitive alerts are prevented from being transmitted over network 111 to client device 110 according to the one or more embodiments as described herein. Advantageously, the one or more embodiments as described herein utilize less network resources (e.g., network bandwidth) when compared to conventional systems and techniques. Additionally, because users are not distracted or desensitized by a barrage of repetitive alerts, which is a problem encountered with conventional systems and techniques, the one or more embodiments as described herein provide an improvement in the existing technological field of cloud computing.

In an embodiment, the transformed alerts that are determined to be new and not correspond to an event that is paused may be published, e.g., transmitted over network 111 to client device 110. The enriched data of the published transformed alerts provides more details for monitoring and remediating cloud computing issues when compared to conventional systems and techniques. Moreover, the consistent format and syntax of the transformed alerts allow for more efficient and effective monitoring/remediating of cloud computing issues when compared to conventional systems and techniques. As such, the one or more embodiments as described herein provide an improvement in the existing technological field of cloud computing.

FIG. 2 is a high-level block diagram of an example cloud computing environment 104A, offering Infrastructure as a Service (IaaS), for managing and transforming alerts generated for cloud computing environments according to the one or more embodiments as described herein. For the example of FIG. 2, the cloud computing environment 104A offers IaaS as the one or more services 108 of FIG. 1. For simplicity and ease of understanding, cloud runtimes 110, cloud infrastructure 114, and cache 124 have been omitted from the cloud computing environment 104A of FIG. 2. However, it is expressly contemplated that according to the one or more embodiments as described herein, the cloud computing environment 104A of FIG. 2 includes cloud runtimes 110, cloud infrastructure 114, and cache 124.

As depicted in FIG. 2, cloud computing environment 104A includes region 1 and region 2. Each region may represent a physical geographical area where different cloud components (e.g., cloud storage 112, virtual machines 202, cloud runtimes 110, cloud infrastructure 114, cache 124, etc.) are deployed and maintained. Although FIG. 2 only includes two regions for simplicity and ease of understanding, it is expressly contemplated that cloud computing environment 104A may include any number of regions. In an embodiment, users operating client devices 110 may select the region, e.g., geographical location, on which their applications (e.g., cloud applications 106) and/or data is to be maintained.

As depicted in FIG. 2, region 1 includes availability zones AZ1 and AZ2, while region 2 includes availability zones AZ3 and AZ4. While a region may represent the broader geographical areas where particular cloud components, i.e., cloud resources, are deployed and maintained, availability zones of the region may be thought of as isolated locations within a region that provide redundancy and fault tolerance. For example, and in an embodiment, availability zones of the same region are located in close proximity to each other but are physically separate. This allows for risk mitigation that might be associated with disasters such as, but not limited to, power outages, earthquakes, etc. Although FIG. 2 includes two availability zones for each of regions 1 and 2, it is expressly contemplated that each of regions 1 and 2 may include a single availability zone or more than two availability zones. As such, the depiction in FIG. 2 of regions 1 and 2 each including two availability zones is for illustrative purposes only.

As depicted in FIG. 2, availability zone AZ1 of region 1 includes at least one virtual server 202A and availability zone AZ4 of region 2 includes at least one virtual server 202B. In an embodiment, each of virtual servers 202A and 202B may be referred to as a virtual machine. Each of virtual servers 202A and 202B may be a portion of physical resources that have been partitioned and emulated to function as an independent computing environment. Such physical resources may include, but are not limited to, CPU (not shown), memory (not shown), network interfaces (not shown), cloud storage 112, etc.

For example, virtual server 202A may be a portion of the physical resources, which includes cloud storage 112A, deployed and maintained at availability zone AZ1 of region 1. Similarly, virtual server 202B may be a portion of the physical resources, which include cloud storage 112B, deployed and maintained at availability zone AZ4 at region 2. For simplicity and ease of understanding availability zones AZ2 and AZ3 of FIG. 3 are illustrated without computing resources. However, it is expressly contemplated that availability zones AZ2 and AZ3 may include any of a variety of different computing resources that are deployed in maintained in availability zones AZ2 and AZ3.

As depicted in FIG. 2, virtual server 202A hosts one or more cloud applications 106A. Additionally, virtual server 202B hosts one or more cloud applications 106B. In an embodiment, users may utilize client devices 110 to allow one or more cloud applications 106A and 106B to be hosted on virtual machines 202A and 202B. As an example, a user named Jane Doe may utilize client device 110 to communicate with cloud computing environment 104A over network 111. Based on the communication, Jane Doe may deploy and maintain Application Alpha, a cloud application, such that Application Alpha is hosted for execution on virtual server 202A of availability zone AZ1 of region 1. Further, Jane Doe may communicate with cloud computing environment 104A over network 111 to allow Application Alpha to also be hosted on virtual server 202B in the event that there is a failure in, for example, region 1 and/or on virtual server 202A. That is, Application Alpha may be hosted on virtual server 202B for redundancy and in case Application Alpha cannot execute on virtual server 202A.

For example, region 1 may go off-line due to a power outage or there may be an issue with virtual server 202A that prevents Application Alpha from executing on virtual server 202A. If Application Alpha cannot execute on virtual server 202A, Application Alpha may be put on-line such that Application Alpha can execute on virtual server 202B.

The physical resources of cloud computing environment 104A that are allocated to region 1 and/or virtual server 202A of region 1 may be monitored by alert generation system 122A. Similarly, the physical resources of cloud computing environment 104A that are allocated to region 2 and/or virtual server 202B of region 2 may be monitored by alert generation system 122B. In an embodiment, alert generation systems 122A and 122B are the same single alert generation system. In an embodiment, alert generation systems 122A and 122B are different alert generation systems.

Alert generation systems 122A and 122B may be any of a variety of cloud alert generation systems as known by those skilled in the art. The generated alerts, for region 1 and region 2 of cloud computing environment 104A, are provided to ASP module 116 that implements the one or more embodiments as described herein.

In an embodiment, and as will be described in further detail below, the ASP module 116 may transform the original alerts, generated by alert generation system 122A and 122B, with enriched data and into a single consistent format and syntax. Further, and as will be described in further detail below, ASP module 116 may suppress or limit the transmission of repetitive transformed alerts, which are generated for cloud computing environment 104A, over network 111 to client device 110. Therefore, the transformed alerts according to the one or more embodiments as described herein have the same look and feel with enriched data such that users are able to monitor and remediate cloud issues more efficiently and effectively when compared to conventional systems and techniques.

In an embodiment, ASP module 116 may enable automatic implementation of a remediation action, of one or more predefined remediation actions, based on an analysis of a transformed alert with enriched data according to the one or more embodiments as described herein. For example, the ASP module 116 may generate a transformed alert with enriched data based on receiving an original generated alert from alert generation system 122A. The transformed alert, generated according to the one or more embodiments as described herein, may include enriched data that indicates that there is an issue with virtual server 202A that executes Application Alpha in availability zone AZ1 of region 1.

Based on an analysis of the transformed alert, the ASP module 116 may automatically send a remediation signal to region 2. The remediation signal may instruct virtual server 202B to bring Application Alpha online such that Application Alpha is accessible and executable via virtual server 202B. Therefore, Application Alpha can be hosted on virtual server 202B for redundancy and as part of a failover technique. By automatically sending the remediation signal based on an analysis of the enriched data of the transformed alert generated according to the one or more embodiments as described herein, an improvement in the existing technological field of cloud computing is provided.

FIG. 3 is a flow diagram of a sequence of steps for managing and transforming alerts generated for cloud computing environments according to the one or more embodiments as described herein. Although the example in relation to FIG. 3 may refer to transforming a single alert and/or suppressing a single alert, it is expressly contemplated that the one or more embodiments as described herein may transform and/or suppress a plurality of alerts in parallel or in series.

The procedure 300 starts at step 305 and continues to step 310. At step 310, the ASP 116 module identifies a cloud alert, i.e., original alert, which corresponds to one or more predefined service names. The predefined service names may correspond to alert generation systems 122, i.e., alert services, which generate alerts for cloud computing services that are of interest to a user/administrator. In an embodiment, the one or more predefined service names may be user defined.

In an embodiment, the ASP module 116 may analyze data contained within an alert to determine if the alert is from an alert generation system 122 with a corresponding predefined service name. For example, the ASP module 116 may determine that if an alert includes particular fields/attributes, then the alert is generated by an alert generation system 122 that corresponds to a predefined service name. If the alert does not include the particular fields/attributes, then the ASP module 116 may determine that the alert is generated by an alert generation system 122 that does not correspond to a predefined service name.

As an example, the particular fields/attributes may be an alarm name field and a new state reason field, where the alarm name field does not include a metric-name. The ASP module 116 may determine that an alert is generated by an alert generation system 122 that has a service name that is one of the predefined service names if the alert (1) includes the alarm name field without a metric-name and (2) includes a new state reason field. The ASP module 116 may determine that an alert is generated by an alert generation system 122 that has as service name that is not one of the predefined service names if the alert (1) does not include the alarm name field without a metric-name or (2) does not include a new state reason field.

Although the example as described herein references particular fields to determine if an alert is generated by an alert generation system 122 having a service name that is one of the predefined service names, it is expressly contemplated that any of a variety of different fields, data, values, etc. may be identified in an alert to determine if the alert is generated by an alert generation system 122 with a service name that is one of the predefined service names. As such, the example used herein is for illustrative purposes only.

The procedure continues from step 310 to step 315. At step 315, the ASP module 116 transforms an original alert, which corresponds to a predefined service name, into a transformed alert with enriched data and having a format that is consistent across different alert generation systems. The original alert may be generated by a particular alert generation system of a plurality of different alert generation systems 122. In an embodiment, the plurality of different alert generation systems 122 use different formats, syntaxes, information, and/or structures to generate and define their respective alerts.

In an embodiment, the enriched data may include cloud application specific information (e.g., cloud application name/identifier) and other cloud environment specific information that is (1) not included in the original alert or (2) not easily identifiable in the original alert.

For example, the enriched data may include, but is not limited to, (1) region information indicating a geographical area where a component (e.g., volume) is allocated, (3) availability zone information indicating an availability zone, of the region, where the component is allocated, (4) an application name/identifier for an application that interacts with the component, (5) severity information indicating a severity of the cloud computing issue that resulted in the generation of the original alert, (6) a suggested remediation indicating a predefined action that can be implemented to address the cloud computing issue, (7) old state information indicating a previous state (e.g., OK or Alarm), for the service corresponding to the origin alert, at a previous point in time, and (8) virtual device information for a virtual device hosting the application that interacts with the component.

In an embodiment, the original alert generated by an alert generation system 122 does not include the enriched data. For example, the original alert does not include cloud application specific information (e.g., cloud application name/identifier) and other types of cloud environment specific information such as availability zone information, region information, etc.

In an embodiment, the ASP module 116 obtains the enriched data from one or more different configuration files and/or tables (e.g., database tables) that are associated with the cloud computing environment 104. Additionally, the ASP module 116 may obtain the enriched data from a different original alert generated from a different alert generation system. For example, let it be assumed that the ASP module 116 is transforming a first original alert from a first alert generation system 122. In an embodiment, the ASP module 116 may generate a transformed alert from the first original alert that includes enriched data obtained from a second alert generated by a second alert generation system 122.

As an example, the ASP module 116 may analyze the original alert to determine if the original alert corresponds to a particular component of the cloud computing environment 104. Specifically, the ASP module 116 may analyze the original alert to determine if the original alert includes a component ID for a component. For this example, let it be assumed that the ASP module 116 analyzes the original alert and identifies a component ID for a volume, i.e., cloud storage 112, of the cloud computing environment 104.

Although the example as described herein includes the ASP module 116 identifying a volume of the cloud computing environment 104 in the original alert, it is expressly contemplated that the ASP module 116 may identify, in the original alert, a different component (processor, network interface, etc.) of the cloud computing environment that is related to a cloud computing issue that resulted in the generation of the original alert. As such, the component ID for the volume in the example is for illustrative purposes only.

In an embodiment, the ASP module 116 may query (i.e., analyze) the configuration files, tables, and/or infrastructure 114 using the component ID. In an embodiment, configuration files and/or tables may be stored in cache 124, cloud storage 112 and/or infrastructure 114. Based on the query, the ASP module 116 may identify an entry that stores a mapping between the component ID of the volume and an application ID of an application that uses and interacts with the volume (e.g., storage volume) in the cloud computing environment 104. The ASP module 116 may enrich the transformed alert, generated according to the one or more embodiments as described herein, with the identified application ID.

The ASP module may query the configuration files, tables, and/or infrastructure 114 using the identified application ID. Based on the query, the ASP module 116 may identify an entry that stores a mapping between the application ID and a virtual server ID representing the virtual server that hosts the application. The ASP module 116 may enrich the transformed alert, generated according to the one or more embodiments as described herein, with the virtual server ID.

The ASP module may query the configuration files, tables, and/or infrastructure 114 using the identified application ID, component ID, and/or virtual server ID. Based on the query, the ASP module 116 may identify a region and/or availability zone of the cloud computing environment 104 corresponding to the component, application, and virtual server. Specifically, the query may result in identifying the region, i.e., geographical location, and/or availability zone where the virtual server, application, and component (e.g., volume) are allocated. The ASP module 116 may enrich the transformed alert, generated according to the one or more embodiments as described herein, with the region and/or availability zone.

The ASP module may query the configuration files, tables using the identified component ID and/or application ID. Based on the query, the ASP module 116 may determine an old, i.e., previous, state of the service corresponding to the alert at a previous point in time. The old state may indicate whether the service was functioning or encountering an issue at the previous point in time. For example, the old state may store a value of “OK” or “Alarm”. The ASP module 116 may enrich the transformed alert, generated according to the one or more embodiments as described herein, with the old state.

Further, ASP module 116 may determine a severity of the alert based on a query of the configuration files, tables, and/or other original alerts from other alert generation systems 122. In an embodiment, the ASP module 116 may determine a severity of an alet based on a type of the alert. For example, an alert that is generated because of increased latency at a volume may be assigned a high severity. The ASP module 116 may enrich the transformed alert, generated according to the one or more embodiments as described herein, with the severity.

Moreover, ASP module 116 may determine a suggested remediation action based on a query of the configuration files, tables, and/or other original alerts from other alert generation systems 122. For example, the ASP module 116 may analyze different resources to identify one or links (e.g., links to remediation documentation/runbook) in a configuration file that provides suggested remediation actions that can be implemented. The ASP module 116 may enrich the transformed alert, generated according to the one or more embodiments as described herein, with the identified remediation/insight. In an embodiment, the suggested remediation action may be one of a plurality of different predefined remediation actions.

Although the example describes enriching a transformed alert with application information, region information, availability zone information, virtual server information, old state information, severity information, and remediation information, it is expressly contemplated that the ASP module 116 may enrich transformed alert in a similar manner with other types of information not included in the original alert and that may assist users/administrators in monitoring and remediating cloud computing issues. Such other types of information may include, but are not limited to, organization specific tags such as product ID, created by, owning business unit and recommended actions for remediation.

The enriched data of the transformed alerts may include information that is more useful to users/administrators in monitoring and/or remediating cloud computing issues when compared to alerts generated by conventional alert generation systems, e.g., alert generation systems 122. In an embodiment, the enriched data includes at least an application of interest that is hosted on cloud computing environment 104 for a user operating client device 110.

In addition to transforming original alerts to include enriched data that may be useful to users/administrators in monitoring and/or remediating cloud computing issues, the one or more embodiments as described herein may also transform original alerts into a consistent format and syntax as will be described in further detail below in relation to FIGS. 4A and 4B.

FIGS. 4A and 4B are exemplary transformed alerts according to the one or more embodiments as described herein. For FIG. 4A, let it be assumed that transformed alert 400A is generated for an original alert from alert generation system 122A of FIG. 2. For FIG. 4B, let it be assumed that transformed alert 400B is generated for an original alert from alert generation system 122B of FIG. 2, wherein alert generation systems 122A and 122B are different.

Transformed alert 400A of FIG. 4A includes original alert information 402A that is one or more portions of the original alert that is generated by alert generation system 122A. For example, the original alert information 402A includes a cloud service account ID field/value, a source field/value, and a component ID field/value.

Similarly, transformed alert 400B of FIG. 4B includes original alert information 402B that recites that “ClusterVolume2 has breached a latency threshold of 500 milliseconds.” In an embodiment, the original alert information 402A and 402B from the alert generation systems 122A and 122B, respectively, do not include cloud application specific information (e.g., cloud application name/identifier) and other cloud environment information such as, but not limited to, region information, availability zone information, virtual server information, severity information, old state information, and remediation information.

For the examples of FIGS. 4A and 4B, the original information is included at the top of transformed alerts 400A and 400B. That is, the original information 402A and 402B are in the same position, e.g., at the top, within transformed alerts 400A and 400B, respectively. According to the one or more embodiments as described herein, the position of the original information within a transformed alert is consistent (i.e., the same) across all transformed alerts that are generated based on original alerts from different alert generation systems 122 that use different formats, syntaxes, etc.

Transformed alerts 400A and 400B also include enriched data 404A and 404B, respectively. The enriched data may correspond to the information determined in step 310 of FIG. 3 as described above. For example, enriched data 404A and/or 404B may include cloud application specific information (e.g., cloud application name/identifier) and other cloud environment information such as, but not limited to, region information, availability zone information, virtual server information, severity information, old state information, and remediation information.

Enriched data 404A of FIG. 4A is structured as a plurality of different fields and corresponding information. According to the one or more embodiments as described herein, the enriched data for all transformed alerts generated by ASP module 116 may have a format, syntax, and structure that is similar to that of enriched data 404A.

Differently, enriched data 404B of FIG. 4B is sentence structured. According to the one or more embodiments as described herein, the enriched data for all transformed alerts generated by ASP module 116 may have a format, syntax, and structure that is similar to that of enriched data 404B. In an embodiment, the structure (e.g., format, syntax, etc.) of the enriched data may be selected by a user operating client device 110.

Enriched data 404A and 404B of FIGS. 4A and 4B are included in a bottom portion of transformed alerts 400A and 400B, respectively. That is, the enriched data 404A and 404B are in the same position, e.g., at the bottom, within transformed alerts 400A and 400B, respectively. According to the one or more embodiments as described herein, the position of the enriched data within a transformed alert is consistent (i.e., the same) across all transformed alerts that are generated based on original alerts from different alert generation systems 122 that use different formats and syntaxes.

Moreover, and according to the one or more embodiments as described herein, the position of the enriched data in relation to the original data in a transformed alert is the same for all transformed alerts. Although the examples of FIGS. 4A and 4B illustrate the original information being on top of the enriched data, it is expressly contemplated that the original information may be below the enriched data or the enriched data and the original information may be next to each other. Alternatively, the original alert information 402A and enriched data 404A may be intermixed with each other, and the field IDs may be in similar locations across all transformed alerts such that all transformed alerts have the same look and feel.

Therefore, the positional relationship of the enriched data and the original information is consistent for all transformed alerts. Advantageously, all transformed alerts, generated according to the one or more embodiments as described herein, have the same look and feel. This is in contrast to conventional alert generation systems, e.g., alert generation systems 122A and 122B, that use different syntaxes, formats, etc. in generating and defining their respective alerts.

Because the alerts are transformed into a consistent format and syntax and with enriched data, cloud computing issues can be monitored and remediated more effectively and efficiently when compared to conventional systems and techniques. As such, the one or more embodiments as described herein provide an improvement in the existing technological field of cloud computing. In an embodiment, a transformed alert generated by ASP module 116 includes enriched data without the original alert generated by alert generation systems 122A and 122B.

Referring back to procedure 300. The procedure continues from step 315 to step 320. At step 320, the ASP module 116 determines if the transformed alert is a new alert or a repetitive alert.

In an embodiment, the ASP module 116 determines if the transformed alert is new or repetitive when the transformed alert is related to an operational aspect of the cloud computing environment. For example, the operational aspects for which alerts may be generated may include, but are not limited to, instance status changes (e.g., when virtual machines are launched, terminated, etc.), storage capacity thresholds, network connectivity issues, service availability, security incidents, resource utilization, system health, backup and restore status, configuration changes, performance monitoring etc.

Examples of non-operational alerts may include, but are not limited to, compliance violations (e.g., alerts notifying deviations from regulatory compliance standards), cost management alerts (e.g., alerts about unexpected spikes in costs or budget overruns), scaling alerts (e.g., alerts when certain auto-scaling thresholds have been reached or exceeded), integration testing alerts during Continuous Integration and Continuous Delivery/Continuous Deployment, etc.

According to the one or more embodiments as described herein, the determination of whether the transformed alert is a new alert or a repetitive alert may be performed for a time frame, i.e., time window. The time window may be user defined. As an example, let it be assumed that a user prefer to receive a transformed alert every 1 hours. Therefore, and according to the one or more embodiments as described herein, the ASP module 116 only publishes a single transformed alert per hour and all other transformed alerts that are determined to be repetitive are suppressed and not published.

In an embodiment, the ASP module 116 may compare the transformed alert with other existing transformed alerts to determine if the transformed alert is new or repetitive. In an embodiment, the ASP module 116 may determine that the transformed alert is repetitive if the transformed alert matches a previously transformed alert, in cloud storage (e.g., database 122) or cache 124, which was previously published within a user defined time window (1 hour). The ASP module 116 may determine that the transformed alert is new if the transformed alert does not match a previously transformed alert, in cloud storage 122 (e.g., database) or cache 124, that was previously published within a user defined time window (1 hour).

In an embodiment, the ASP module 116 may compare the application ID and component ID of the transformed alert with all other existing transformed alerts stored in cache 124 and cloud storage 112 (e.g., database) within the user defined time window. In this example, the time window is 1 hour. As such, the ASP module 116 evaluates all other existing transformed alerts that were generated within the 1 hour time window and stored in cache 124 and cloud storage 112 (e.g., database). The ASP module 116 may determine that the transformed alert is repetitive if:
1. The current status (i.e., current state) of the transformed alert is the same as the previous status (i.e., previous state) of a previous alert stored in cache 124, wherein the previous alert has the matching application ID and component ID and was generated in the time window, or
2. The current status of the transformed alert is the same as the previous status of a previous alert stored in cloud storage 112 (e.g., database), wherein the previous alert has the matching application ID and component ID and was generated in the time window.

Otherwise, the ASP module 116 determines that the transformed alert is new. Specifically, the ASP module determines that the transformed alert is new if:
1. The current status of the transformed alert is different from the previous status of a previous alert stored in cache 124, wherein the previous alert has the matching application ID and component ID and was generated in the time window, and
2. The current status of the transformed alert is different from the previous status of a previous alert stored in cloud storage 112 (e.g., database), wherein the previous alert has the matching application ID and component ID and was generated in the time window.

If the ASP module 116 determines that the alert is new at step 320, the procedure continues to step 325. At step 325, the ASP module 116 determines whether the event corresponding to the transformed alert, determined to be a new alert, is paused or not. For example, the ASP module 116 may query the configuration files and/or database corresponding to the cloud computing environment 104 to determine whether the event is paused or not. For example, a maintenance window may be a type of paused event.

If, at step 325 the ASP module 116 determines that the event corresponding to the transformed alert is paused, the procedure continues to step 330. Further, if the ASP module 116 determines that the transformed alert is repetitive at step 320, the procedure also continues to step 330. At step 330, the ASP module 116 determines that the transformed alert should not be published. In the case where the transformed alert is repetitive in the time window, the ASP module 116 determines that the transformed alert should not be published so that a user/administrator is not distracted or desensitized by repetitive alerts. As such, the ASP module 116 knows that the transformed alert (i.e., repetitive alert) does not need to be provided to the user/administrator since the user/administrator has already been previously notified of the issue within the defined time frame.

In the case where the transformed alert corresponds to an event that has been paused, the ASP module 116 also determines that the transformed alert should not be published.

The procedure continues from step 330 to step 335. At step 335, the ASP module 116 modifies the transformed alert to include a publish field and stores a value in the publish field indicating that the identified alert should not be published. In an embodiment, the ASP module 116 may generate a new field to be inserted in the transformed alert and the alert may store one or more alphanumeric characters, e.g., False, indicating that the transformed alert with the new field should not be published. As such, and when the ASP module 116 analyzes the modified alert and encounters the one or more alphanumeric characters (e.g., False) in the new field, the ASP module 116 may prevent the transformed alert from being published.

Referring back to step 325, if the ASP module 116 determines that the event corresponding to the transformed alert is not paused, the procedure continues to step 340. At step 340, the ASP module 116 determines that the transformed alert, which is determined to be new and corresponds to an event that is not paused, should be published.

Because the ASP module 116 determines that the transformed alert is not repetitive and not associated with a paused event, the ASP module 116 determines that the transformed alert should be published so that a user/administrator has access to the transformed alert for monitoring and/or remediation purposes. That is, the ASP module 116 determines at step 340 that the transformed alert is not a repetitive alert of a barrage of different repetitive alerts that may negatively affect a user's ability to effectively and efficiently monitor and/or remediate the issue in the cloud computing environment 104 that corresponds to the transformed alert. As such, the ASP module 116 knows that the transformed alert (i.e., new alert) needs to be provided to the user/administrator since the user/administrator has not been previously notified of the issue corresponding to the identified alert within the user defined time window.

After determining that the transformed alert should be published at step 340, the procedure continues to step 345. At step 345, the ASP module 116 modifies the transformed alert to include a publish field and stores a value in the publish field indicating that the transformed alert should be published. In an embodiment, the ASP module 116 may generate a new field to be inserted in the transformed alert and the transformed alert may store one or more alphanumeric characters, e.g., True, indicating that the transformed alert with the new field should be published. As such, and when the ASP module 116 analyzes the transformed alert and encounters the one or more alphanumeric characters (e.g., True) in the new field, the ASP module 116 may publish the transformed alert.

At step 350, the ASP module 116 publishes the transformed alert. In an embodiment, the ASP module 116 may publish the transformed alert in a report that is transmitted over network 111 to one or more different client devices 110. In addition or alternatively, the transformed alert may be published by transmitting the transformed alert over network 111 as an email notification to a user/administrator that operates client device 110. The transformed alert may also be published in any of a variety of different ways as known by those skilled in the art.

In an embodiment, the transformed alerts may be published at a predefined time or a predefined scheduled. For example, a transformed alert may be published or not published when the transformed alert is being stored in cloud storage 112 (e.g., database).

A user/administrator may utilize the published transformed alerts to monitor and remediate cloud computing issues more efficiently and effectively when compared to conventional cloud computing systems that generate alerts without enriched data and with inconsistent formats/syntaxes.

Specifically, and as described above, repetitive alerts are prevented from being transmitted over network 111 to client device 110 operated by users/administrators according to the one or more embodiments as described herein. Advantageously, users/administrators are not distracted or desensitized by a barrage of repetitive alerts, which is a problem encountered by conventional systems and techniques. Because users/administrators are not distracted or desensitized, the users/administrators can more efficiently and effectively monitor and remediate cloud computing issues.

Further, and because the published transformed alerts are transformed into a consistent format and syntax, the transformed alerts according to the one or more embodiments as described herein have the same look and feel. This is in contrast to conventional alert generation systems that use different formats, syntaxes, information, and/or structures to define and generate alerts. Because of the different formats syntaxes, etc., the alerts generated across different conventional alert generation systems do not have the same look and feel. As such, users/administrators have to be keenly familiar with all the different formats, syntaxes etc. to properly understand the alerts generated by conventional alert generation systems.

According to the one or more embodiments as described herein, the transformed alerts have a consistent format and syntax. As such, user/administrators only have to be familiar with the single format and syntax used for the transformed alerts. This allows users/administrators to monitor and remediate cloud computing issues more easily and effectively when compared to conventional systems.

Moreover, the transformed alerts are enriched with additional data, not included in the original alerts, which can be utilized to assist in monitoring and remediating cloud computing issues. As such, the one or more embodiments as described herein provide an improvement in the existing technological field of cloud computing.

As an example, let it be assumed that transformed alert 400B of FIG. 4B is published over network 111 to a user operating client device 110. The user may utilize the enriched data 404B of transformed alert 400B, which is not included in the original alert, to more effectively monitor and remediate cloud computing issues. Specifically, the user can determine that volume ClusterVolume2 is attached to virtual server VMB that hosts ApplicationBeta. Moreover, the user can determine that volume ClusterVolume2 is allocated to availability zone 2 in a west European region. Further, the user can determine that a best course of action for remediating the cloud computing issue is to follow instructions in electronic guideline AA.

Accordingly, the user can utilize the enriched data to implement one or more remediation actions. For example, the user may utilize client device 110 to instantiate the execution of ApplicationBeta on a different volume of a different availability zone in the same region (e.g., west Europe) or a different region as part of a failover technique. Alternatively, the user may utilize the client device to transition ApplicationBeta from virtual server VMB to a different virtual server in the west Europe region. Even more, the user may utilize the client device 110 to modify the configuration settings for ApplicationBeta such that ApplicationBeta interacts differently with volume ClusterVolume2 to remediate the issue. Alternatively, the user may utilize the client device 110 to implement the instructions provided in electronic guidelines AA.

Therefore, the user can use the enriched data, which is not included in the original alert generated by alert generation system 122B, to more robustly and effectively implement different remediation actions to rectify the cloud computing issue. That is, the enriched data provides the user with information that allows the user to implement remediation actions that would not be identifiable from the information contained in the original alert generated by alert generation system 122B. As such, the one or more embodiments as described herein provide an improvement in the existing technology of cloud computing.

The procedure continues to step 355. At step 355, the ASP module 116 optionally performs one or more remediation actions based on an analysis of the transformed alert. In an embodiment, the client device 110 may choose to initiate a self-healing action that instructs the ASP module 116 to automatically perform one or more remediation actions based on an analysis of the transformed alert.

As an example, let it be assumed that the ASP module 116 analyzes transformed alert 400A of FIG. 4A. Based on the analysis, the ASP module 116 can identify the “suggested_action” field of enriched data 404A of transformed alert 400A. The ASP module 116 may identify the suggested action stored in the “suggested_action” field and automatically (e.g., without user intervention) send a remediation signal to a different operational volume, in this case VolumeYY, that is allocated in availability zone Zone2 of region USWest. In an embodiment, the ASP module 116 sends a remediation signal to implement a failover technique when the transformed alert indicates that the old state is ok, the state (i.e., current state) is Alarm, and the severity is High. That is, and in an embodiment, the values of one or more fields, alone or in any combination, may dictate which remediation action should be implemented by ASP module 116.

The remediation signal may cause VolumeYY to bring hosted ApplicationAlpha online until the cloud computing issue is rectified. By automatically performing the failover technique to a different operational volume based on the analysis of the transformed alert generated according to the one or more embodiments as described herein, the ASP module 116 provides an improvement in the existing technological field of cloud computing. In an embodiment, the ASP module 116 may transmit a further remediation signal as part of a failback technique when the cloud computing issue is rectified and ApplicationAlpha is operational on ClusterVolume1 of availability zone Zone1 of region USEast.

The procedure continues from step 355 to step 360. At step 360, the procedure ends.

It should be understood that a wide variety of adaptations and modifications may be made to the techniques. For example, the steps of the flow diagrams as described herein may be performed sequentially, in parallel, or in one or more varied orders. As another example, the one or more embodiments as described herein may be appliable to cloud-based environments (e.g., cloud-based storage environments) that, for example, host different applications. In general, functionality may be implemented in software, hardware or various combinations thereof. Software implementations may include electronic device-executable instructions (e.g., computer-executable instructions) stored in a non-transitory electronic device-readable medium (e.g., a non-transitory computer-readable medium), such as a non-volatile memory, a persistent storage device, or other tangible medium. Additionally, it should be understood that the term user and customer may be used interchangeably. Hardware implementations may include logic circuits, application specific integrated circuits, and/or other types of hardware components. Further, combined software/hardware implementations may include both electronic device-executable instructions stored in a non-transitory electronic device-readable medium, as well as one or more hardware components. Above all, it should be understood that the above description is meant to be taken only by way of example.

1. A computer-implemented method for noise reduction in a cloud-based computing environment, the method comprising:
identifying an alert, generated for the cloud-based computing environment, containing data corresponding to one or more predefined service names, wherein each of the one or more predefined service names corresponds to a different alert service and the alert is generated when one or more metrics corresponding to an operation of a service of the cloud-based computing environment meets a threshold;
determining whether the alert is a new alert or a repetitive alert;
in response to determining that the alert is the new alert, determining that the alert should be published by setting a value in a publish field, corresponding to the alert, to a first value;
in response to determining that the alert is the repetitive alert, determining that the alert should not be published by setting the value in the publish field to a second value or;
storing the alert with the corresponding publish field in a database;
analyzing, at a predetermined time, the database to identify one or more first different alerts with a corresponding publish field with the first value; and
publishing the one or more first different alerts over a computer network to one or more client devices.

2. The computer-implemented method of claim 1, wherein
the alert includes one or more fields and/or one or more first values that indicate that the alert was generated by a particular alert generation system.

3. The computer implemented method of claim 1, wherein determining whether the alert is the new alert or the repetitive alert, the method further comprising:
identifying a first previous alert stored in a database that has a same application identifier and a same component identifier as the alert;
identifying a second previous alert stored in cache that has the same application identifier and the same component identifier as the alert;
determining that the alert is the new alert when (1) a current status of the alert is not a same value as a first previous status of the first previous alert stored in the database, and (2) the current status of the alert is not the same value as a second previous status of the second previous alert stored in the cache, and
determining that the alert is the repetitive alert when (1) the current status of the alert is the same value as the first previous status of the first previous alert stored in the database, or (2) the current status of the alert is the same value as the previous status of the previous alert stored in the cache.

4. The computer-implemented method of claim 3, the method further comprising:
publishing the alert when the alert is new and a notification status corresponding to the alert is not set to paused; and
preventing the alert from being published when the alert is repetitive or the notification status corresponding to the alert is set to paused.

5. The computer-implemented method of claim 1, further comprising:
transforming the alert to include one or more additional fields for storing information that includes one or more of (1) region information indicating a geographical area where a component, impacted by an issue that resulted in the generation of the alert, is allocated, (2) availability zone information indicating an identifier for an availability zone, of the region, wherein the component is allocated, (3) an application identifier indicating an application that interacts with the component, (4) a suggested remediation action indicating one or more predefined actions to implement to address the issue, (5) a virtual device identifier for a virtual device hosting the application that interacts with the component.

6. The computer-implemented method of claim 5, wherein the transformed alert is generated from a first alert generation system and a second transformed alert is generated from a second alert generation system that is different from the first alert generation system, wherein the transformed alert and the second transformed alert have a same format with same fields.

7. The computer-implemented method of claim 1, further comprising:
analyzing, at the predetermined time, the database to identify one or more second different alerts with a corresponding publish field with the second value; and
preventing the one or more second different alerts from publishing over the computer network to the one or more client devices.

8. The computer-implemented method of claim 1, further comprising:
analyzing a selected first different alert of the one or more first different alerts;
identifying particular information stored within the selected first different alert;
in response to identifying the particular information, (1) automatically performing one or more predetermined remediation actions for the cloud-based computing environment or (2) initiating a self-healing action that automatically performs the one or more predetermined remediation actions for the cloud-based computing environment.

9. The computer-implemented method of claim 8, wherein the one or more predetermined remediation actions includes a failover technique where the service is switched from executing on a first cloud-based device to a second cloud-based device of the cloud-based computing environment and a failback technique where the service is switched from executing on the second cloud based device to the first cloud-based device of the cloud computing environment.

10. A system for noise reduction in a cloud-based computing environment, the system comprising:
a software module executed by a processor of the cloud-based computing environment, the software module configured to:
identify an alert, generated for the cloud-based computing environment, containing data corresponding to one or more predefined service names, wherein each of the one or more predefined service names corresponds to a different alert service and the alert is generated when one or more metrics corresponding to an operation of a service of the cloud-based computing environment meets a threshold;
determine whether the alert is a new alert or a repetitive alert;
determine, in response to determining that the alert is the new alert, that the alert should be published by setting a value in a publish field, corresponding to the alert, to a first value;
determine, in response to determining that the alert is the repetitive alert, that the alert should not be published by either (1) setting the value in the publish field to a second value or (2) maintaining the publish field as null;
store the alert with the corresponding publish field in a database;
analyze, at a predetermined time, the database to identify one or more first different alerts with a corresponding publish field with the first value; and
publish the one or more first different alerts over a computer network to one or more client devices.

11. The system of claim 10, wherein
the alert includes one or more fields and/or one or more first values that indicate that the alert was generated by a particular alert generation system.

12. The system of claim 10, wherein determining whether the alert is the new alert or the repetitive alert, the software module is further configured to:
identify a first previous alert stored in a database that has a same application identifier and a same component identifier as the alert;
identify a second previous alert stored in cache that has the same application identifier and the same component identifier as the alert;
determine that the alert is the new alert when (1) a current status of the alert is not a same value as a first previous status of the first previous alert stored in the database, and (2) the current status of the alert is not the same value as a second previous status of the second previous alert stored in the cache, and
determine that the alert is the repetitive alert when (1) the current status of the alert is the same value as the first previous status of the first previous alert stored in the database, or (2) the current status of the alert is the same value as the previous status of the previous alert stored in the cache.

13. The system of claim 12, the software module further configured to:
publish the alert when the alert is new and a notification status corresponding to the alert is not set to paused; and
prevent the alert from being published when the alert is repetitive or the notification status corresponding to the alert is set to paused.

14. The system of claim 10, wherein the software module is further configured to:
transform the alert to include one or more additional fields for storing information that includes one or more of (1) region information indicating a geographical area where a component, impacted by an issue that resulted in the generation of the alert, is allocated, (2) availability zone information indicating an identifier for an availability zone, of the region, wherein the component is allocated, (3) an application identifier indicating an application that interacts with the component, (4) a suggested remediation action indicating one or more predefined actions to implement to address the issue, (5) a virtual device identifier for a virtual device hosting the application that interacts with the component.

15. The system of claim 14, wherein the transformed alert is generated from a first alert generation system and a second transformed alert is generated from a second alert generation system that is different from the first alert generation system, wherein the transformed alert and the second transformed alert have a same format with same fields.

16. The system of claim 10, wherein the software module is further configured to:
analyze, at the predetermined time, the database to identify one or more second different alerts with a corresponding publish field with the second value; and
prevent the one or more second different alerts from publishing over the computer network to the one or more client devices.

17. The system of claim 10, wherein the software module is further configured to:
analyze a selected first different alert of the one or more first different alerts;
identify particular information stored within the selected first different alert;
in response to identifying the particular information, (1) automatically perform one or more predetermined remediation actions for the cloud-based computing environment or (2) initiating a self-healing action that automatically performs the one or more predetermined remediation actions for the cloud-based computing environment.

18. The system of claim 17, wherein the one or more predetermined remediation actions includes a failover technique where the service is switched from executing on a first cloud-based device to a second cloud-based device of the cloud-based computing environment and a failback technique where the service is switched from executing on the second cloud based device to the first cloud-based device of the cloud computing environment.

19. A non-transitory computer readable medium having software encoded thereon, the software when executed by one or more computing devices operable to:
identify an alert, generated for the cloud-based computing environment, containing data corresponding to one or more predefined service names, wherein each of the one or more predefined service names corresponds to a different alert service and the alert is generated when one or more metrics corresponding to an operation of a service of the cloud-based computing environment meets a threshold;
determine whether the alert is a new alert or a repetitive alert;
determine, in response to determining that the alert is the new alert, that the alert should be published by setting a value in a publish field, corresponding to the alert, to a first value;
determine, in response to determining that the alert is the repetitive alert, that the alert should not be published by either (1) setting the value in the publish field to a second value or (2) maintaining the publish field as null;
store the alert with the corresponding publish field in a database;
analyze, at a predetermined time, the database to identify each of one or more first different alerts with a corresponding publish field with the first value; and publish the one or more different first alerts over a computer network to one or more client devices.

20. The non-transitory computer readable medium of claim 19, the software when executed by the one or more computing devices further operable to:
transform the alert to include one or more additional fields for storing information that includes one or more of ((1) region information indicating a geographical area where a component, impacted by an issue that resulted in the generation of the alert, is allocated, (2) availability zone information indicating an identifier for an availability zone, of the region, wherein the component is allocated, (3) an application identifier indicating an application that interacts with the component, (4) a suggested remediation action indicating one or more predefined actions to implement to address the issue, (5) a virtual device identifier for a virtual device hosting the application that interacts with the component.
